(19) United States
(12) Patent Application Publication
(10) Pub. No.: US 2018/0205244 A1
(43) Pub. Date: Jul. 19, 2018

(54) HAND-HELD ELECTRIC POWER TOOL

(71) Applicant: MAKITA CORPORATION, Anjo-shi, Aichi (JP)

(72) Inventors: Yoshitaka ICHIKAWA, Anjo-shi (JP); Takuya KUSAKAWA, Anjo-shi (JP); Hideki KACHI, Anjo-shi (JP)

(73) Assignee: MAKITA CORPORATION, Anjo-shi, Aichi (JP)

(21) Appl. No.: 15/742,107

(22) PCT Filed: May 13, 2016
(86) PCT No.: PCT/JP2016/064356

§ 371 Date: Jan. 5, 2018

(30) Foreign Application Priority Data
Jul. 13, 2015 (JP) 2015-139874

(51) Int. Cl. H02J 7/00; H01H 9/06; B25F 5/02

(52) U.S. Cl. CPC H02J 7/0032; H01H 9/06; H02J 2007/0067; H02J 7/0036; H02J 2007/004; B25F 5/02

(57) ABSTRACT

A hand-held electric power tool includes a main power SW provided in a motor housing, a trigger SW provided in a grip portion that protrudes from the motor housing, and a controller. The controller switches an operation mode to one of a drive enabled mode in which driving of the motor is enabled and a drive disabled mode in which driving of the motor is disabled, in accordance with a switching command from the main power SW. In the drive enabled mode, driving of the motor is controlled in accordance with a driving command input from the trigger SW. The controller switches the operation mode to the drive disabled mode in response to the driving of the motor being stopped due to stopping input of the drive command from the trigger SW.

### CROSS-REFERENCE TO RELATED APPLICATION

This international application claims the benefit of Japanese Patent Application No. 2015-139874 filed on Jul. 13, 2015 with the Japan Patent Office, the entire disclosure of which is incorporated herein by reference.

### TECHNICAL FIELD

The present disclosure relates to a hand-held electric power tool such as an electric chainsaw, an electric circular saw, an electric blower, or the like.

### BACKGROUND ART

A hand-held electric power tool is provided with a grip for a user to hold with a hand to operate. Also, the grip is provided with a trigger switch so that the user can operate the trigger switch with a finger while holding the grip with a hand.

The hand-held electric power tool includes a motor serving as a power source and a control unit for controlling driving of the motor. The control unit controls driving of the motor in accordance with an operation of the trigger switch by the user (see Patent Document 1, for example).

### PRIOR ART DOCUMENTS

### Patent Documents

Patent Document 1: Japanese Unexamined Patent Application Publication No. 2011-136541

### SUMMARY OF THE INVENTION

### Problems to be Solved by the Invention

In the case that the hand-held electric power tool is configured such that the control unit can drive the motor at any time when the electric power tool is coupled to a battery or a commercial power supply, there is a possibility that the motor may be driven contrary to the user's intention due to erroneous operation or the like of the trigger switch, which is inconvenient.

For this reason, the hand-held electric power tool may be provided with, for example, a main power switch for switching enabling/disabling driving of the motor, apart from the trigger switch, and the user may switch off the main power switch, thereby disabling driving of the motor.

However, such a measure causes the control unit to control driving of the motor in accordance with the operation of the trigger switch, until the main power switch is switched from the on state to the off state by the user.

Therefore, for example, if the user holds the grip in an attempt to displace the hand-held electric power tool while forgetting to switch off the main power switch, the trigger switch may be erroneously operated and the motor may be driven.

According to one aspect of the present disclosure, it is desirable that driving of a motor due to erroneous operation of a trigger switch can be inhibited, even if a user forgets to operate a main power switch of a hand-held electric power tool.

### Means for Solving the Problems

A hand-held electric power tool according to one aspect of the present disclosure includes a motor, a trigger switch, a main power switch, and a controller.

The trigger switch and the main power switch are externally operated by a user. The trigger switch is used to input a drive command of the motor, and the main power switch is used to input a switching command for enabling/disabling driving of the motor.

In accordance with the switching command from the main power switch, the controller switches an operation mode to one of a drive enabled mode in which driving of the motor is enabled and a drive disabled mode in which driving of the motor is disabled. In the drive enabled mode, driving of the motor is controlled in accordance with the drive command input from the trigger switch.

The controller is configured to switch the operation mode to the drive disabled mode in response to the driving of the motor being stopped due to stopping input of the drive command from the trigger switch.

Therefore, in the hand-held electric power tool according to one aspect of the present disclosure, if the user operates the trigger switch to drive the motor and then ends the operation of the trigger switch while the operation mode of the controller is the drive enabled mode, the operation mode of the controller is automatically switched to the drive disabled mode.

Therefore, according to the hand-held electric power tool of one aspect of the present disclosure, after the user operates the trigger switch to perform a desired operation, the motor is no longer driven even if the user operates the trigger switch thereafter. Therefore, according to the present disclosure, the motor is inhibited from being driven contrary to the user's intention. Also, usability of the hand-held electric power tool can be improved.

Particularly, in one aspect of the present disclosure, the main power switch and the trigger switch are disposed at a distance from each other so that the switches are not turned on at the same time by a user merely holding the electric power tool.

Therefore, for example, when the user carries the hand-held electric power tool, it is possible to inhibit both the main power switch and the trigger switch from being turned on, contrary to the user's intention, and the motor from being driven at the same time that the operation mode of the controller is switched to the drive enabled mode.

In this case, the main power switch may be provided in a main body in which the motor is housed, and the trigger switch may be provided in a grip portion protruding from the main body to be held by a user during use of the electric power tool.

In this way, when the user holds the grip portion and operates the trigger switch to use the electric power tool, it is necessary that the user intentionally operates the main power switch in order to switch the controller from the drive disabled mode to the drive enabled mode to drive the motor.

In other words, if a finger of a hand holding the grip portion is extended to the main body to operate the main power switch, or if the main power switch on the main body side is operated with a hand not holding the grip portion, the user can operate the main power switch in a state in which the grip portion is held (in other words, a state in which the user can operate the trigger switch).

Therefore, if the hand-held electric power tool is configured as such, it is possible not only to inhibit the main power switch and the trigger switch from being turned on contrary to the user's intention, but also to inhibit causing deterioration of operability of the hand-held electric power tool due to the difficulty of operating these switches.

The hand-held electric power tool according to one aspect of the present disclosure may include an informing unit that reports an operation state of the electric power tool. In this case, the controller may be configured to determine whether the electric power tool is in proper state and, if it is determined that the electric power tool is in improper state, to report the improper state of the electric power tool via the informing unit regardless of whether the operation mode is the drive enabled mode or the drive disabled mode.

In this way, the improper state of the electric power tool is reported not only when the controller is in an ordinary operation state (in other words, the drive enabled mode) as in a general electric power tool, but also when the controller is in a control operation stop state (in other words, in the drive disabled mode).

Therefore, when the motor is not driven even if the trigger switch is operated, the user can confirm whether the cause is due to the improper state (failure) of the electric power tool. Usability of the electric power tool can be improved.

In addition, if the improper state of the electric power tool is reported while the operation mode of the controller is the drive disabled mode, the user can understand the cause when the user is unable to drive the motor by operation of the trigger switch.

Therefore, this technique can be applied even to an electric power tool that is not configured to switch the operation mode to the drive disabled mode when the controller stops driving of the motor due to stopping input of the drive command from the trigger switch.

Likewise, this technique can be applied, for example, even to an electric power tool in which a main power switch and a trigger switch are provided in a grip portion and a user can simultaneously operate both the switches with a single hand.

Upon reporting the improper state of the electric power tool via the informing unit as described above, the informing unit may be provided with one or more indicator lamps for displaying whether the operation mode of the controller is the drive enabled mode or the drive disabled mode.

In this case, the controller may be configured to switch a lighting state of the indicator lamp to a lighting state different from those of the drive enabled mode and the drive disabled mode upon determining improper state of the electric power tool, so as to report the improper state of the electric power tool.

Further, in a case of reporting the improper state of the electric power tool via the informing unit as described above, the controller may be configured to determine whether the electric power tool is proper in a plurality of states, and, if it is determined that the electric power tool is improper in any one of the plurality of states, to report content of the improper state via the informing unit.

In addition, upon reporting the improper state of the electric power tool via the informing unit while the operation mode is the drive disabled mode, the controller may be configured to stop an improper state report from the informing unit in response to establishment of a specified report stop condition.

In this way, it is possible to reduce power consumption consumed by reporting the improper state of the electric power tool via the informing unit while the operation mode is the drive disabled mode.

The report stop condition may be established in response to a report time of the improper state reaching a specified time while the operation mode of the controller is the drive disabled mode, in response to a battery voltage of a battery that supplies electric power to the electric power tool dropping to a specific threshold voltage, in response to a report stop command input by external operation of a user, or a combination of the foregoing.

On the other hand, the trigger switch may include a lock release portion for fixing the trigger switch to a non-operation position and for releasing the position fixing of the trigger switch by external operation.

In this case, since the trigger switch cannot be operated unless the lock release portion is operated, erroneous operation of the trigger switch can be more satisfactorily inhibited. Further, since it is possible to inhibit the motor from being driven by erroneous operation, unnecessary power consumption associated with driving of the motor can be reduced.

### BRIEF DESCRIPTION OF THE DRAWINGS

FIG. 1 is a perspective view showing an entire configuration of a chainsaw according to an embodiment.

FIG. 2 is a block diagram showing an electrical configuration of the chainsaw according to the embodiment.

FIG. 3A is an explanatory diagram for explaining a state display using a state display unit, and FIG. 3B is an explanatory diagram for explaining a state display using a remaining energy display unit.

FIG. 4 is a flowchart showing a control process executed by a control circuit in FIG. 2.

FIG. 5 is a flowchart showing a motor drive enabling management process executed in S130 in FIG. 4.

FIG. 6 is a flowchart showing a motor control process executed in S160 in FIG. 4;

FIG. 7 is a flowchart showing a display process executed in S170 in FIG. 4;

FIG. 8 is a perspective view showing another configuration example of the chainsaw.

### EXPLANATION OF REFERENCE NUMERALS

2, 2a . . . chainsaw, 3 . . . saw chain, 4 . . . body, 6 . . . guide bar, 8 . . . battery pack, 9 . . . battery, 10 . . . motor, 12 . . . first grip, 14 . . . second grip, 16 . . . hand guard, 18 . . . trigger SW, 19, 19a . . . lock release lever, 20 . . . operation panel, 21 . . . main power SW, 22 . . . state display unit, 24 . . . remaining energy display unit, 30 . . . motor driver, 32 . . . drive circuit, 34 . . . gate circuit, 36 . . . control circuit, 38 . . . memory, 40 . . . regulator, 42 . . . battery voltage detector, 44 . . . current detection circuit, 46 . . . rotation sensor, 48 . . . temperature sensor.

### MODE FOR CARRYING OUT THE INVENTION

An embodiment of the present disclosure will be described below with reference to the accompanying drawings.

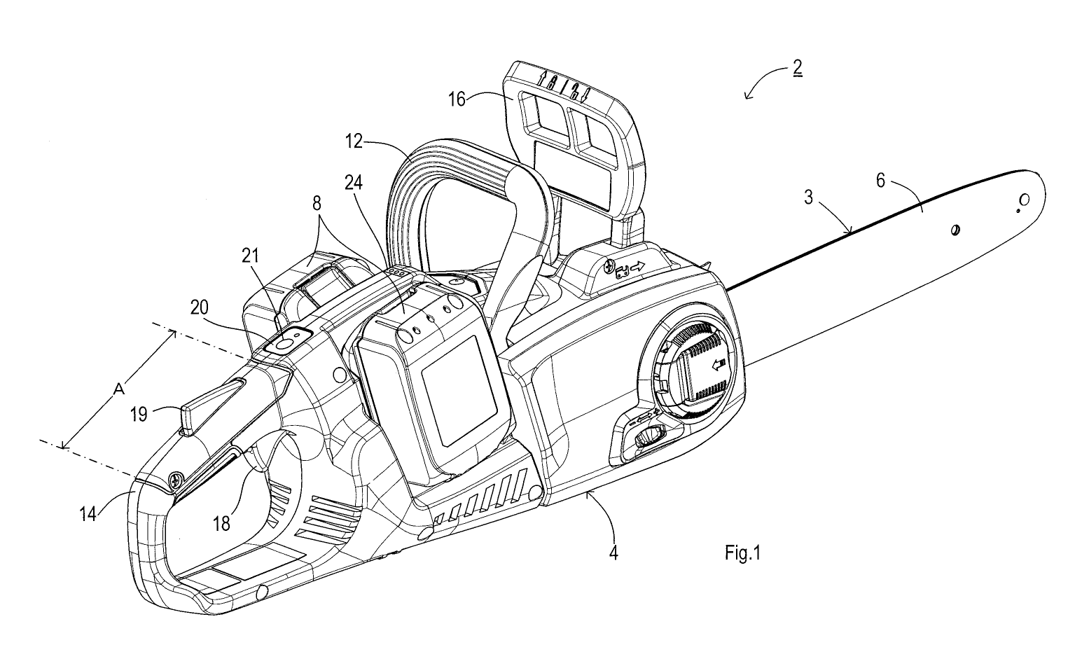

As shown in FIG. 1, a chainsaw 2 of the present embodiment is a kind of hand-held electric power tool, and includes a guide bar 6 around which a saw chain 3 is attached, and a main body 4 from which the guide bar 6 protrudes.

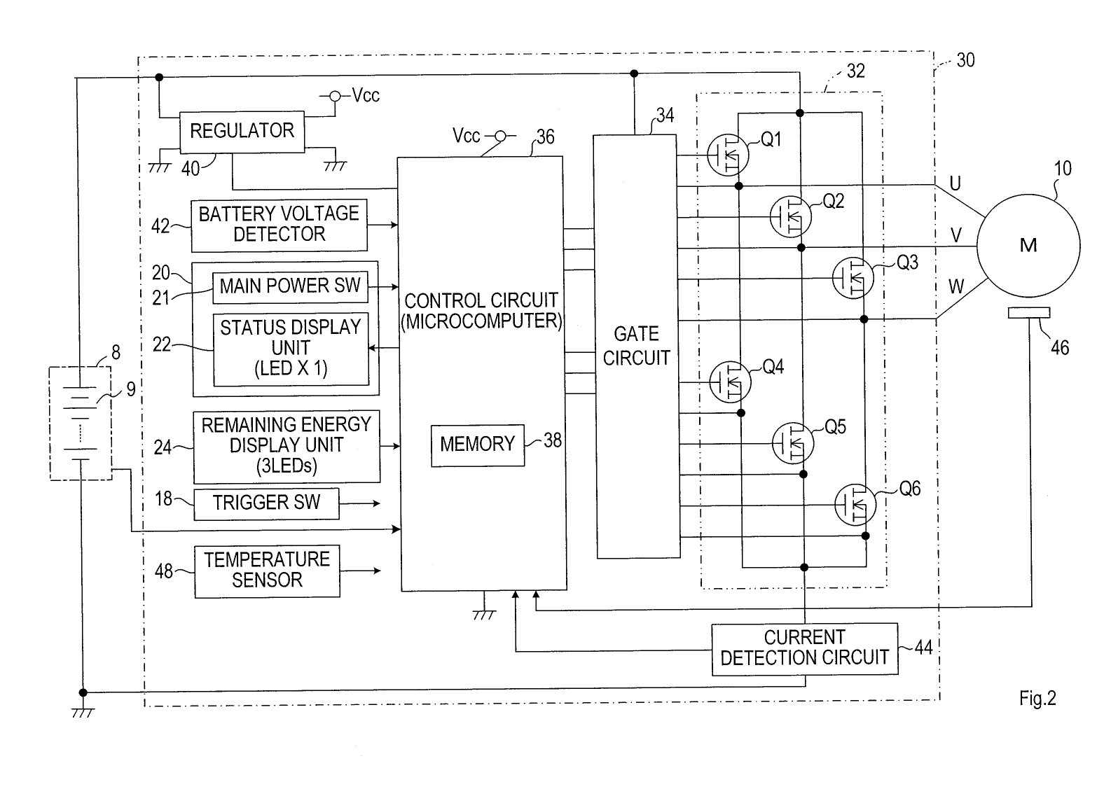

The guide bar 6 rotatably supports the saw chain 3, together with a sprocket (not shown) in the main body 4. A motor 10 (see FIG. 2) that rotatably drives the saw chain 3 by rotating the sprocket is housed in the main body 4.

In addition, the main body 4 includes a first grip 12 and a second grip 14 to be held by a user with left and right hands, respectively.

Assuming that a protruding direction of the guide bar 6 from the main body 4 is the front, the first grip 12 protrudes from a central upper part in a front-rear direction of the main body 4. A hand guard 16 coupled to an emergency stop mechanism (not shown) of the motor 10 is provided in further front of the first grip 12.

A pair of battery packs 8 are detachably fixed to right and left side walls of the main body 4 in the rear of the first grip 12. The second grip 14 protrudes rearward from an attachment portion of the battery packs 8.

In a grip portion (region A shown in FIG. 1) of the second grip 14 to be held by a user when using the chainsaw 2, a trigger switch (hereinafter referred to as “trigger SW”) 18 is provided at a position where operation of the trigger SW 18 can be made with the hand holding the grip portion (A). Specifically, the trigger SW 18 is provided below a part of the grip portion (A) protruding from the main body 4.

The trigger SW 18 is a well-known switch configured to be turned on by an operation of the user and to be able to output a signal corresponding to an operation amount of the trigger SW 18. The trigger SW 18 is coupled to a control circuit 36 of a motor driver 30 housed inside the main body 4 together with the motor 10 (see FIG. 2).

Further, in the grip portion (A) of the second grip 14, a lock release lever 19 is provided on a side opposite to the trigger SW 18 (specifically, above the part of the grip portion (A) protruding from the main body 4).

The lock release lever 19 corresponds to an example of a lock release portion of the present disclosure. The lock release lever 19 engages with the trigger SW 18 inside the second grip 14 (or the main body 4) to fix (lock) the trigger SW 18 to the non-operation position. When the lock release lever 19 is depressed to the second grip 14 side by a user, the engagement with the trigger SW 18 is released and the trigger SW 18 becomes operable.

Therefore, in the chainsaw 2 of the present embodiment, if the second grip 14 is held while depressing the lock release lever 19 from above, the trigger SW 18 can be operated with a fingertip. However, if the lock release lever 19 is not depressed, the trigger SW cannot be operated.

Since the lock release lever 19 as above is well known in an electric power tool, a detailed description of its configuration will be omitted.

An operation panel 20 is provided in a portion where the second grip 14 protrudes rearward on an upper wall surface of the main body 4. Further, a remaining energy display unit 24 for displaying remaining energy of the battery 9 in the battery pack 8 (an amount of electric power remaining in the battery 9) is provided in further front of the operation panel 20.

The operation panel 20 includes a main power switch (hereinafter referred to as a main power SW) 21, and a state display unit 22 for displaying operation/stop (in detail, enabling/disabling of driving of the motor 10 by the control circuit 36) of the chainsaw 2.

The main power SW 21, the state display unit 22, and the remaining energy display unit 24 are coupled to the control circuit 36 of the motor driver 30 (see FIG. 2).

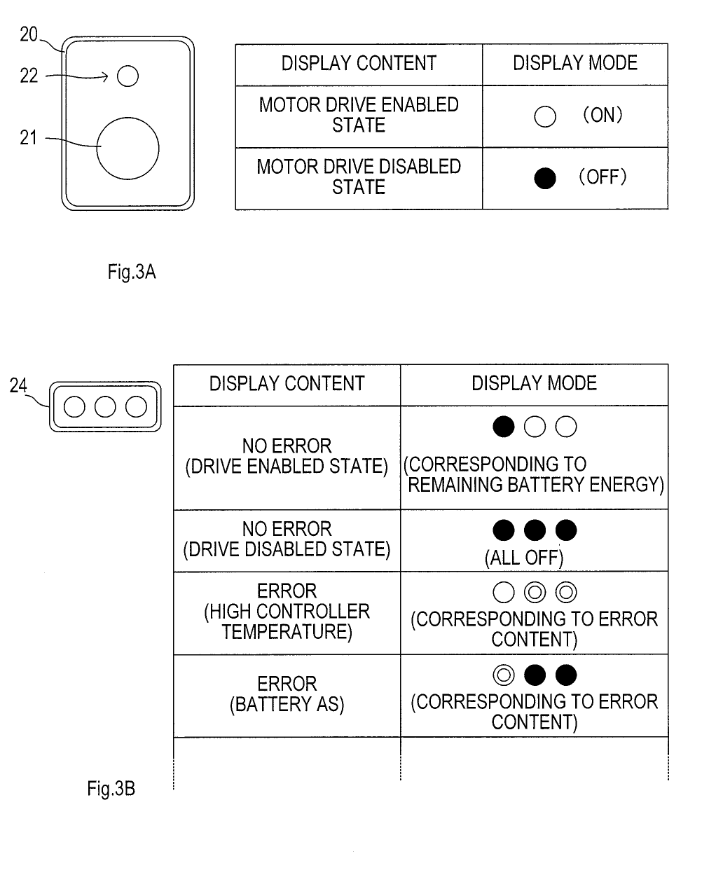

Note that the state display unit 22 and the remaining energy display unit 24 correspond to an example of an informing unit of the present disclosure. As shown in FIG. 3A, the state display unit 22 includes a single LED as a so-called power indication lamp. Further, as shown in FIG. 3B, the remaining energy display unit 24 includes three LEDs so that the remaining energy of the battery can be confirmed from their lighting states.

The motor driver 30 receives power supply from the battery 9 in the battery pack 8 to control driving of the motor 10. As shown in FIG. 2, the motor driver 30 includes a drive circuit 32, a gate circuit 34, a control circuit 36, and a regulator 40.

The drive circuit 32 receives power supply from the battery 9 to deliver a current to each phase winding of the motor 10. In the present embodiment, the drive circuit 32 is configured as a three-phase full bridge circuit including six switching elements Q1 to Q6. Each of the switching elements Q1 to Q6 is a MOSFET in this embodiment.

In the drive circuit 32, the three switching elements Q1 to Q3 are provided as so-called high side switches between the terminals U, V, W of the motor 10 and a power supply line coupled to a positive electrode of the battery 9.

The other three switching elements Q4 to Q6 are provided as so-called low side switches between the terminals U, V and W of the motor 10 and a ground line coupled to a negative electrode of the battery 9.

In accordance with a control signal output from the control circuit 36, the gate circuit 34 turns on and off each of the switching elements Q1 to Q6 in the drive circuit 32 so as to deliver a current to each phase winding of the motor 10 to rotate the motor 10.

The control circuit 36 is configured by a microcomputer (microcomputer) including a CPU, a ROM, a RAM and the like. Further, the control circuit 36 also includes a nonvolatile memory 38 for storing states (improper state, etc.) of the motor 10 to be controlled and the motor driver 30.

The trigger SW 18, the main power SW 21, the state display unit 22, and the remaining energy display unit 24 described above are coupled to the control circuit 36.

The motor driver 30 includes a battery voltage detector 42 for detecting a battery voltage, a current detection circuit 44 for detecting a current flowing to the motor 10, and a temperature sensor 48 for detecting a temperature of the motor driver 30. These portions are also coupled to the control circuit 36.

Further, the motor 10 includes a rotation sensor 46 for detecting a rotational position and a rotational speed of the motor 10. The rotation sensor 46 is also coupled to the control circuit 36.

Further, the battery pack 8 includes a monitoring circuit (not shown) for monitoring states (temperature, cell voltage, etc.) of the battery 9 and outputting a stop signal AS (autostop) for stopping discharge from the battery 9 in the event of improper state. The control circuit 36 is also coupled to the monitoring circuit.

Each time the main power SW 21 (push button type switch in the present embodiment) is depressed, the operation mode of the control circuit 36 is switched to one of a drive enabled mode in which power supply to the motor 10 is enabled and a drive disabled mode in which power supply to the motor is disabled.

As illustrated in FIG. 3A, the control circuit 36 turns on an LED of the state display unit 22 when the operation mode of the control circuit 36 is the drive enabled mode, and turns off the LED of the state display unit 22 when the operation mode is the drive disabled mode.

Accordingly, by viewing the LED (state display unit 22) of the display panel 20, a user can confirm whether the control circuit 36 is in the drive enabled mode in which the motor 10 can be driven or in the drive disabled mode in which the motor 10 cannot be driven (in other words, operation/stop state of the chainsaw 2).

If the trigger SW 18 is operated when the operation mode is the drive enabled mode, the control circuit 36 controls driving of the motor 10 in accordance with the operation amount of the trigger SW 18 to drive the chainsaw 2.

When the operation mode is the drive enabled mode, the control circuit 36 determines whether the motor 10, the motor driver 30, and the battery pack 8 are in proper state based on detection signals from the battery voltage detector 42, the current detection circuit 44, the rotation sensor 46, and the temperature sensor 48.

The control circuit 36, when the operation mode is the drive enabled mode, also monitors an input of the stop signal AS from the battery pack 8, apart from the improper state determination (hereinafter, referred to as error determination).

The control circuit 36, when detecting improper state by the error determination or monitoring the stop signal AS, stops driving the motor 10 and uses the three LEDs of the remaining energy display unit 24 to report the detected error content.

In other words, if the motor 10, the motor driver 30 and the battery pack 8 are in proper state when the operation mode is the drive enabled mode, the control circuit 36 turns on the number of LEDs, out of the three LEDs of the remaining energy display unit 24, in accordance with remaining energy of the battery, as shown in FIG. 3B.

In FIGS. 3A and 3B, a white circle indicates “on”, a black circle indicates “off”, and a double circle indicates “blinking”, of the LEDs of the remaining energy display unit 24.

In FIG. 3B, the remaining energy of the battery is indicated by the left LED being off, and the remaining two LEDs being on. Therefore, from the states of the state display unit 22 and the remaining energy display unit 24, the user can detect that the current operation mode is the drive enabled mode, and that about ⅔ of energy in a fully charged state remains in the battery 9.

If the motor 10, the motor driver 30 and the battery pack 8 are in proper state when the operation mode is switched to the drive disabled mode, the control circuit 36 turns off all of the three LEDs of the remaining energy display unit 24. For this reason, the user can confirm from the states of the state display unit 22 and the remaining energy display unit 24 that the current operation mode is the drive disabled mode and that no error has occurred in the chainsaw 2.

On the other hand, for example, when the motor driver 30 detected by the temperature sensor 48 exceeds an allowable temperature (controller high temperature) and the driving of the motor 10 is stopped, the control circuit 36 causes the left side LED of the remaining energy display unit 24 to be on and the remaining LEDs to blink so as to report the error content.

Further, for example, when the stop signal AS is input from the battery pack 8 and the driving of the motor 10 is stopped, the control circuit 36 causes the left side LED of the remaining energy display unit 24 to blink, and the remaining LEDs to be off so as to report the error content.

The control circuit 36 continues the report (display) of the error content once starting the report of the error content, regardless of whether the operation mode is switched to the drive disabled mode from the drive enabled mode.

Therefore, when an error occurs in the chainsaw 2, the user can confirm occurrence of the error and the error content from the state of the remaining energy display unit 24 even if the control circuit 36 is in the drive enabled mode or the drive disabled mode.

Hereinafter, a control process executed by the control circuit 36 to implement the above operation will be described below.

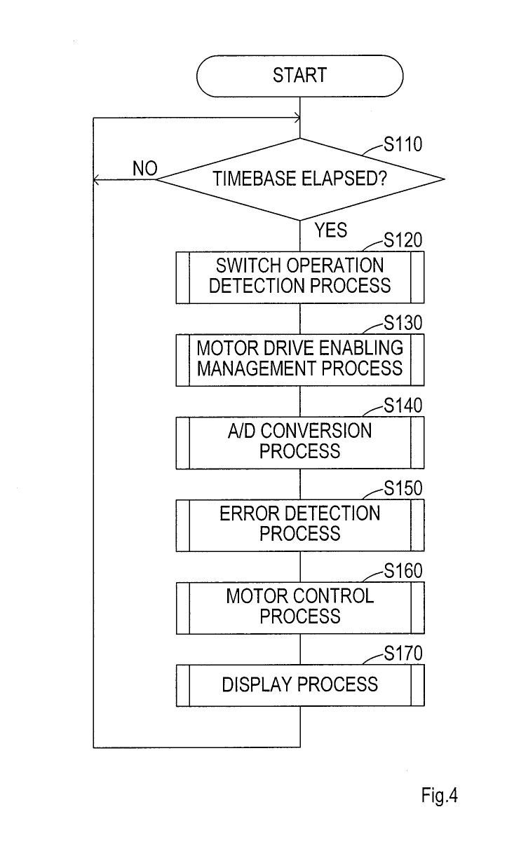

As shown in FIG. 4, the control circuit 36 repeatedly executes a series of processing from S120 to S160 (S represents a step) at a specified control period (time base).

The control circuit 36 determines whether the time base has elapsed in S110, thereby waiting till the specified control period elapses. If it is determined that the time base has elapsed in S110, the process proceeds to S120.

In S120, signal inputs from the trigger SW 18 and the main power SW 21 are checked, so as to execute a switch operation detection process for detecting operation of each switch by the user.

In subsequent S130, based on the operation state of each switch detected in S120, a motor drive enabling management process is executed in which the operation mode of the control circuit is set to one of the drive enabled mode and the drive disabled mode.

In S140, an A/D conversion process is executed to A/D convert the operation amount of the trigger SW 18, and detection results by the battery voltage detector 42, the current detection circuit 44, and the temperature sensor 48.

In subsequent S150, an error detection process for performing the above-described error determination is executed based on the detection results (battery voltage, current, temperature, etc.) read in S140, the stop signal AS input from the battery pack 8, the detection signal (pulse signal) from the rotation sensor 46, etc.

In S160, a motor control process for controlling driving of the motor 10 in accordance with the operation amount of the trigger SW 18 is executed.

When the operation mode set in S130 is the drive disabled mode, power supply from the battery 9 to the gate circuit 34 is cut off to turn off the switching elements Q1 to Q6 in the drive circuit 32 in S160, so as to stop driving of the motor 10.

In S160, even when the improper state is detected in S150 during driving of the motor 10, driving of the motor 10 is stopped.

When the motor control process is executed in S160, the process moves to S170 to execute a display process, and then proceeds to S110.

As shown in FIGS. 3A and 3B, the display process of S170 is a process for displaying the remaining battery energy, the drive enabled/disabled mode, presence/absence of an error of the chainsaw 2, and the error content on the remaining energy display unit 24.

The motor drive enabling management process executed in S130 will now be described.

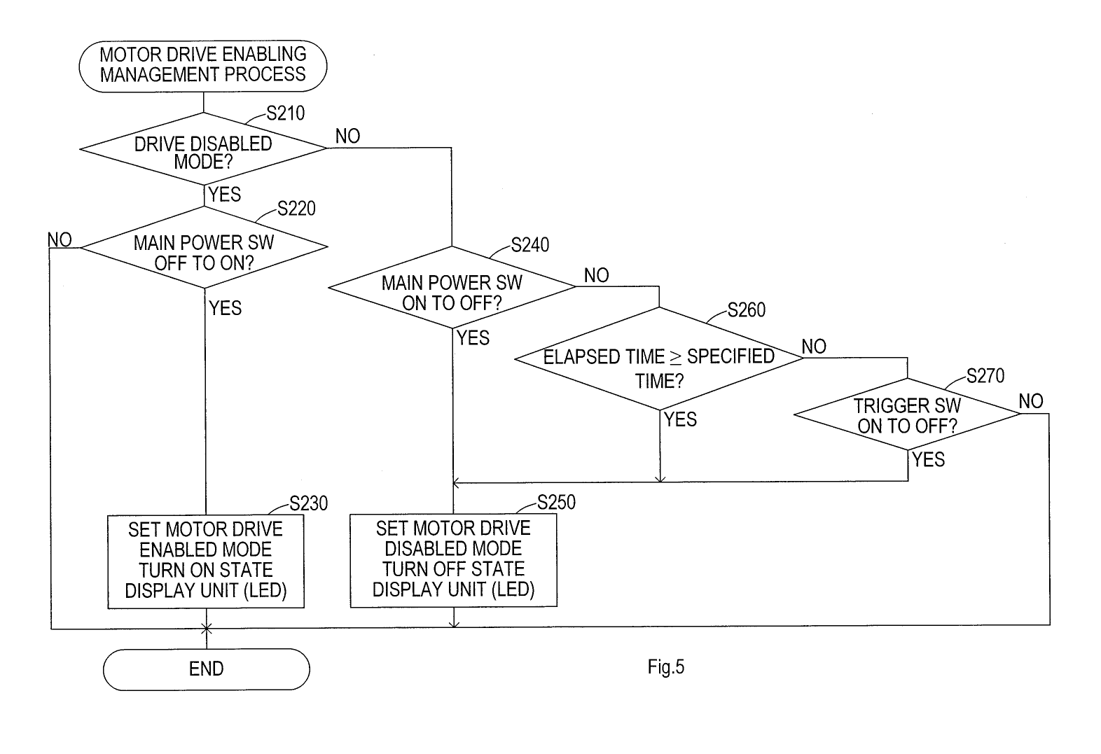

As shown in FIG. 5, in the motor drive enabling management process, it is determined first in S210 whether the current operation mode is the drive disabled mode. If the operation mode is the drive disabled mode, the process proceeds to S220, where it is determined whether the main power SW 21 is operated to switch the operation mode.

When it is determined in S220 that the main power SW 21 is operated and the operation mode is switched, the process moves to S230, where the operation mode of the control circuit 36 is set to the drive enabled mode, and the motor drive enabling management process is terminated. If it is determined in S220 that the main power SW 21 is not operated, the motor drive enabling management process is immediately terminated.

When the operating mode is set to the drive enabled mode in S230, the LED in the state display unit 22 is turned on to report that the operation mode is the drive enabled mode (in other words, the chainsaw 2 is operable by an operation of the trigger SW 18).

When it is determined in S210 that the current operation mode is not the drive disabled mode (in other words, the operation mode is the drive enabled mode), the process proceeds to S240, where it is determined whether the main power SW 21 is operated and the operation mode is switched.

When it is determined in S240 that the main power SW 21 is operated and the operation mode is switched, the process proceeds to S250, where the operation mode of the control circuit 36 is set to the drive disabled mode to end the motor drive enabling management process.

When the operating mode is set to the drive disabled mode in S250, the LED of the state display unit 22 is turned off to report that the operation mode is the drive disabled mode (in other words, chainsaw 2 does not work even if the trigger SW 18 is operated).

On the other hand, if it is determined in S240 that the main power SW 21 is not operated, the process proceeds to S260.

In S260, it is determined whether an elapsed time from when the operation mode of the control circuit 36 is switched to the drive enabled mode till the trigger SW 18 is operated to be on is equal to or greater than a preset specified time.

When it is determined that the elapsed time is equal to or greater than the specified time (i.e., if the trigger SW 18 is not operated for the specified time or more after the operation mode of the control circuit 36 is switched to the drive enabled mode), the process proceeds to S250, where the operation mode of the control circuit 36 is set to the drive disabled mode to end the motor drive enabling management process.

When it is determined in S260 that the elapsed time till the trigger SW 18 is operated is not equal to or greater than the specified time, the process proceeds to S270, where it is determined whether the trigger SW 18 is switched to be off after operated to be on.

When it is determined in S270 that the trigger SW 18 is not switched from on to off, the motor drive enabling management process is terminated.

Further, when it is determined in S270 that the trigger SW 18 is switched from on to off, the process proceeds to S250, where the operation mode of the control circuit 36 is set to the drive disabled mode and the motor drive enabling management process is terminated.

Hereinafter, a description will be given on the motor control process executed in S160.

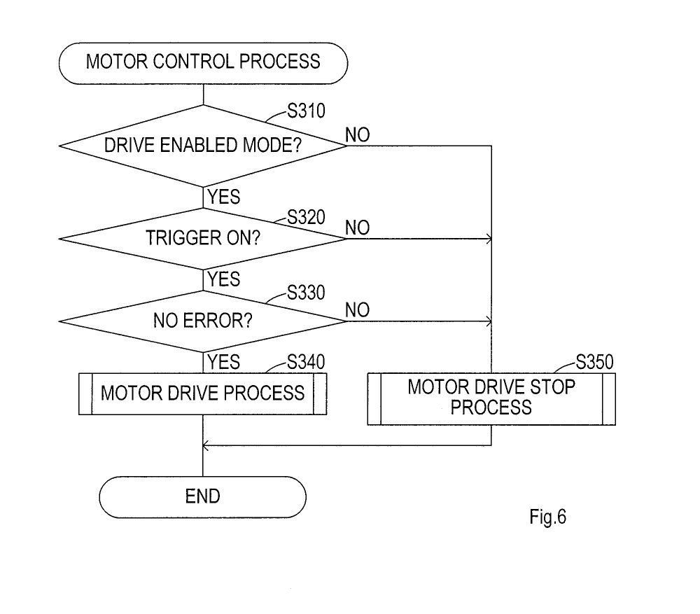

In the motor control process, it is first determined in S310 whether the current operation mode is not the drive enabled mode, as shown in FIG. 6. If the operation mode is the drive enabled mode, the process proceeds to S350, where a motor drive stop process for stopping the driving of the motor 10 is executed to end the motor control process.

When it is determined in S310 that the current operation mode is the drive enabled mode, the process proceeds to S320, where it is determined whether the trigger SW 18 is on. If the trigger SW 18 is not on, the motor drive stop process of S350 is executed to end the motor control process. If the trigger SW 18 is on, the process proceeds to S330.

In S330, it is determined whether no error is detected in the error detection process of S150. If it is determined that no error is not detected, the motor drive stop process of S350 is executed to end the motor control process. If it is determined that no error is detected, the process proceeds to S340, where the motor drive process for driving the motor 10 in accordance with the operation amount of the trigger SW 18 is executed, and the motor control process is terminated.

A description will now be given of the display process to be executed in S170.

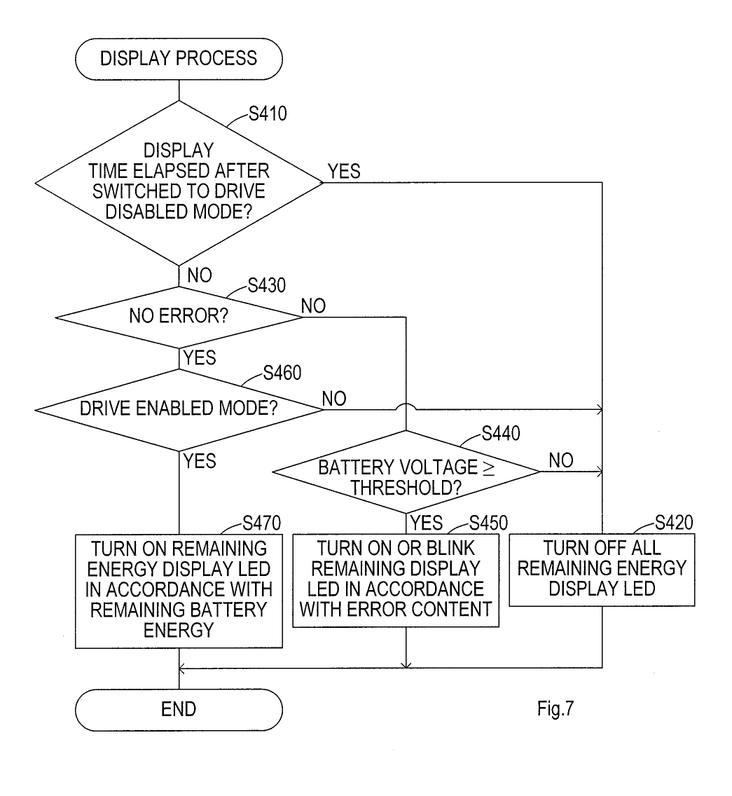

In the display process, it is first determined in S410 whether a specified display time has elapsed after the operation mode of the control circuit 36 is switched to the drive disabled mode, as shown in FIG. 7. If it is determined in S410 that the display time has elapsed, all three LEDs of the remaining energy display unit 24 are turned off in S420 to end the display process.

On the other hand, if it is determined in S410 that the current operation mode is not the drive disabled mode, or, the specified display time has not elapsed even if the operation mode is the drive disabled mode, the process proceeds to S430.

In S430, it is determined whether no error is detected in the error detection process of S150. If it is determined that no error is detected, the process proceeds to S460. If it is determined that no error is not detected, the process proceeds to S440.

In S440, it is determined whether the battery voltage detected by the battery voltage detector 42 is equal to or greater than a preset threshold for overdischarge protection (in other words, a display lower limit voltage). If the battery voltage is less than the threshold, the display process is terminated after all of the LEDs of the remaining energy display unit 24 are turned off in S420. If the battery voltage is equal to or greater than the threshold, the process proceeds to S450.

In S450, the LED of the remaining energy display unit 24 is blinked in accordance with the error content detected by the error detection process to display (report) the error content. In S450, as illustrated in FIG. 3B, various kinds of error contents detected in the error detection process are displayed by not only causing the LED of the remaining energy display unit 24 to blink, but also turning on or off the LEDs other than the LED to blink.

In S460, it is determined whether the current operation mode is the drive enabled mode. Unless the operation mode is the drive enabled mode (in other words, if the operation mode is the drive disabled mode), the process proceeds to S420, where all the LEDs of the remaining energy display unit 24 are turned off, and the display process is terminated.

If the operation mode is the drive enabled mode, the process proceeds to S470. As illustrated in FIG. 3B, the LEDs of the remaining energy display unit 24 are turned on in accordance with the remaining battery energy to display (report) the remaining battery energy, and the display process is terminated.

As described above, in the chainsaw 2 of the present embodiment, when the trigger SW 18 is operated during a period from when the main power SW 21 is operated to switch the operation mode to the drive enabled mode until the specified time elapses, the motor 10 is driven in accordance with the operation amount of the trigger SW 18.

Thereafter, when the operation of the trigger SW 18 is stopped, driving of the motor 10 is stopped and the operation mode is switched to the drive disabled mode.

Therefore, according to the chainsaw 2 of the present embodiment, after the user operates the trigger SW 18 and performs a desired operation, the operation mode is switched automatically to the drive disabled mode. Even if the user operates the trigger SW 18 thereafter, driving of the motor 10 is stopped.

Thus, according to the chainsaw 2 of the present embodiment, even if the user erroneously operates the trigger SW 18 after the work is performed, the motor 10 is not driven, so that usability of the chainsaw 2 is improved.

The trigger SW 18 is provided to a grip portion (A) of the second grip 14 that protrudes from the main body 4 and is held by the user when the user uses the chainsaw 2. Therefore, the user can easily operate the trigger SW 18 while holding the grip portion (A) of the second grip 14 (in other words, when using the chainsaw 2).

In contrast, the main power SW 21 is provided not on the grip portion (A) of the second grip 14 but on an upper wall surface of the main body 4 from which the grip portion (A) protrudes.

Therefore, if the user simply holds the second grip 14 to carry the chainsaw 2, there is no possibility that the trigger SW 18 and the main power SW 21 are simultaneously turned on to drive the motor 10.

On the other hand, when the user holds the grip portion (A) of the second grip 14 to use the chainsaw 2, the user can reach out a finger (thumb, etc.) of a hand holding the grip portion (A) to operate the main power SW 21. In this case, even with the opposite hand to the hand holding the grip portion (A), the user can operate the main power SW 21.

In other words, the user, when holding the grip portion (A) of the second grip 14 in order to use the chainsaw 2, can not only operate the trigger SW 18, but also can operate the main power SW 21 if desired.

Therefore, according to the chainsaw 2 of the present embodiment, not only the main power SW 21 and the trigger SW 18 can be inhibited from being switched on, contrary to the user's intention, but also deterioration of operability of the chainsaw 2 can be inhibited due to difficulty in operating these switches.

Further, according to the chainsaw 2 of the present embodiment, if improper state occurs in the motor 10 to be controlled, the motor driver 30 or the battery pack 8 when the control circuit 36 is in the drive enabled mode, the improper state is detected and displayed on the remaining energy display unit 24. Then, the error display continues even when the operation mode is switched to the drive disabled mode.

Therefore, according to the chainsaw 2 of the present embodiment, when some improper state occurs, the improper state is displayed at all times on the remaining energy display unit 24. The user can look at the remaining energy display unit 24 to be aware of the improper state of the chainsaw 2.

Particularly, in the present embodiment, the error content is distinguishably reported at the time of error detection by the combinations of on, off or blinking of the three LEDs provided in the remaining energy display unit 24. Therefore, the user can understand the error content from a display state of the remaining energy display unit 24, and take appropriate measures.

In the chainsaw 2 of the present embodiment, after the trigger SW 18 is operated to drive the motor 10, the motor 10 becomes unable to be driven even if the trigger SW 18 is operated. In this case, the operating mode is switched to the drive disabled mode and all the LEDs of the remaining energy display unit 24 are turned off. Therefore, the user can confirm that the motor 10 can no longer be driven by the operation of the trigger SW 18 (in other words, the operation mode is the drive disabled mode) from the display state of the remaining energy display unit 24.

Further, in the present embodiment, when an error is displayed in the drive disabled mode, the display time is limited. Moreover, even if the display time does not reach the limit time, the error display is switched to the display of the drive disabled mode (i.e., all LEDs are off) if the battery voltage falls below the threshold.

Accordingly, it is possible to reduce power consumption of the battery 9 when the operation mode is the drive disabled mode.

In the display process shown in FIG. 7, when all the LEDs of the remaining energy display unit 24 are turned off in S420, operation of the regulator 40 may be stopped so that power consumption of the motor driver 30 becomes zero (0).

In this case, if power supply from the regulator 40 to the control circuit 36 is started to activate the control circuit 36 in the next time the main power SW 21 is operated, the control circuit 36 can properly execute the series of control processing described above.

The second grip 14 provided with the trigger SW 18 includes the lock release lever 19 which can be depressed when the user holds the second grip 14. When the lock release lever 19 is depressed, the trigger SW 18 can be operable.

Therefore, according to the chainsaw 2 of the present embodiment, the trigger SW 18 is not operable unless the lock release lever 19 is operated (depressed). This configuration can better inhibit erroneous operation of the trigger SW 18.

Further, since it is possible to inhibit the motor 10 from being driven by erroneous operation of the trigger SW 18, unnecessary power consumption associated with driving the motor 10 can be inhibited.

In the present embodiment, the control circuit 36 corresponds to an example of a controller of the present disclosure, the state display unit 22 and the remaining energy display unit 24 correspond to an example of an informing unit of the present disclosure.

An embodiment of the present disclosure has been described in the above. The present disclosure is not to be limited to the disclosed embodiment, but may take various forms within the scope not departing from the gist of the present disclosure.

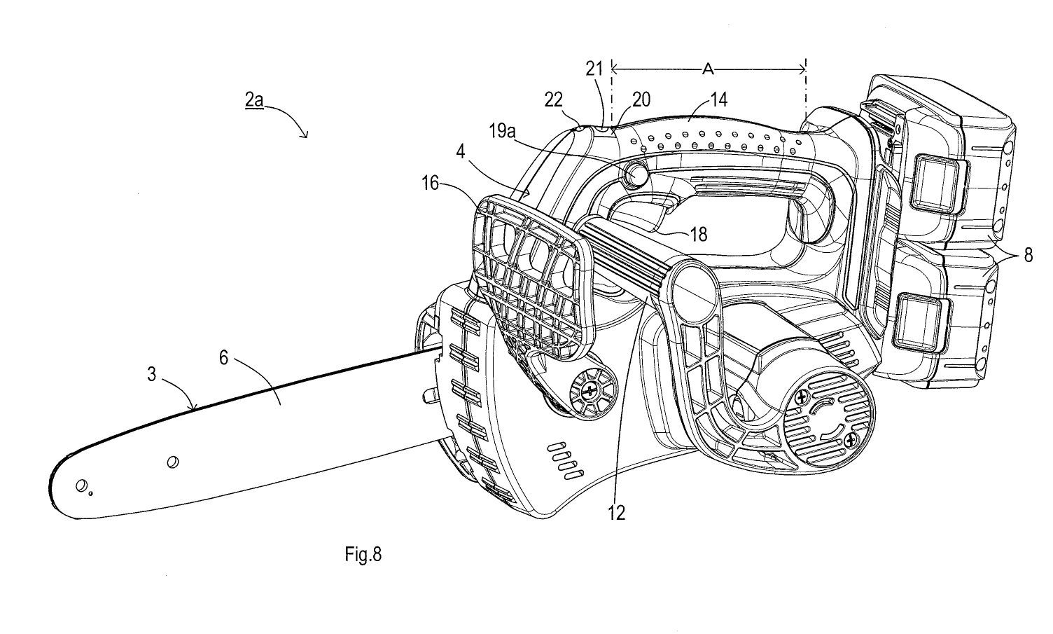

For example, the above embodiment describes the chainsaw 2 in which the second grip 14 provided with the trigger SW 18 protrudes rearward of the main body 4. However, the present disclosure can be configured in the same manner as the above embodiment, even with a chainsaw 2a in which the second grip 14 is provided above the main body 4, as illustrated in FIG. 8.

In the chainsaw 2a shown in FIG. 8, the battery pack 8 is attached to a rear end of the main body 4. The second grip 14 is provided to bridge the attachment portion and a front main body portion from which the guide bar 6 protrudes.

Therefore, substantially the entire area in the front-rear direction of the second grip 14 becomes the grip portion (A) for a user to hold when using the chainsaw 2. The trigger SW 18 is provided in front of and below the grip portion (A).

Further, a lock release button 19a, as a lock release member, having the same function as the lock release lever 19 is provided on a side wall of the grip portion (A) provided with the trigger SW 18.

The operation panel 20 having the main power SW 21 is assembled to the upper wall surface of the main body 4 from which the second grip 14 protrudes rearward. Further in front, a single LED corresponding to the state display unit 22 is provided.

Also in the chainsaw 2a configured as such, the main power SW 21 is disposed at a position where operation of the main power SW 21 is not possible by just gripping the grip portion (A) of the second grip 14 (i.e., at the main body 4 side).

Therefore, the main power SW 21 and the trigger SW 18 are not simultaneously turned on to drive the motor 10 in the main body 4, only by the user holding the grip portion (A) of the second grip 14 to use the chainsaw 2a, contrary to the user's intention.

The main power SW 21 can be operated by extending a finger (thumb, etc.) of the hand holding the grip portion (A). Thus, as in the embodiment described above, deterioration of operability of the chainsaw 2 can be inhibited.

The chainsaw 2a shown in FIG. 8 is merely provided with the state display unit 22 including a single LED as the informing unit. Thus, as described later, by turning on, off or blinking the LED, the operation state (drive enabled/disabled mode) and an error state may be reported.

Further, in FIGS. 1 and 8, the main power SW 21 is provided on the upper wall surface near the second grip 14 of the main body 4. The position of the main power SW 21 may be a position to be reached by a finger of the user holding the grip portion (A) of the second grip 14. Thus, the main power SW 21, for example, may be provided on a side wall of the main body 4.

In the above embodiment, it is described that the error display in the drive disabled mode is limited based on the display time and the battery voltage. The error display may be stopped by a report stop command from a user.

In this case, the report stop command may be input by an operation of the trigger SW 18 or the main power SW 21 (e.g., short-time operation, number of the operations), or may be input by operation of another switch provided in the remaining energy display unit 24.

Also, in this case, it may be determined in the display process whether the report stop command is input simultaneously with the determination of the battery voltage in S440, or in place of the determination of the battery voltage.

In the above embodiment, it is described that the LEDs provided in the state display unit 22 and the remaining energy display unit 24 are used to report a main power state and the error state. However, the informing unit, like the state display unit 22, may be a display unit configured from a single indicator lamp including a LED or the like.

In this case, for example, the indicator lamp may be turned on in the drive enabled mode, may be turned off in drive disabled mode, and may blink at the time of detecting an error. In this manner, the operation state of the electric power tool (drive enabled/disabled mode) and the error state may be reported. Also, in this case, the error content can be reported by a blinking period and the number of times of blinking of the indicator lamp.

Further, the informing unit may include a plurality of indicator lamps including LEDs or the like, like the remaining energy display unit 24. Even in this case, the operation state of the electric power tool (drive enabled/disabled mode) and various error states can be reported by changing a display pattern (on, off, or blinking) of each indicator lamp.

A voice output unit for reporting a state by sound or voice may be used as the informing unit of the present disclosure, instead of the display unit including an LED or the like or together with the display unit.

In the above embodiment, it is descried that the main power SW 21 is of a push-button type, but may be a slide-type switch or a switch that can self-hold an on/off state of a contact.

In the above embodiment, the present disclosure is described as applied to the chainsaw 2 which operates upon receipt of power supply from the battery pack 8. The present disclosure can be similarly applied to any hand-held electric power tools in the same manner as the above-described embodiment. Also, the hand-held electric power tool may be a rechargeable electric power tool receiving power supply from a battery pack or may be an electric power tool receiving AC power from a commercial power source to operate.

1. A hand-held electric power tool comprising:
a motor;
a trigger switch used to input a drive command of the motor by external operation;
a main power switch used to input a switching command for enabling/disabling driving of the motor by external operation; and
a controller that switches an operation mode to one of a drive enabled mode in which driving of the motor is enabled and a drive disabled mode in which driving of the motor is disabled in accordance with the switching command from the main power switch, the controller in the drive enabled mode controlling driving of the motor in accordance with the drive command input from the trigger switch,
the controller being configured to switch the operation mode to the drive disabled mode in response to the driving of the motor being stopped due to stopping input of the drive command from the trigger switch,
the main power switch and the trigger switch being disposed at a distance from each other so that the switches are not turned on at the same time by a user merely holding the electric power tool.

2. The hand-held electric power tool according to claim 1,
wherein the main power switch is provided in a main body which houses the motor, and
wherein the trigger switch is provided in a grip portion protruding from the main body to be held by a user during use of the electric power tool.

3. The hand-held electric power tool according to claim 1, further comprising:
an informing unit for reporting an operation state of the electric power tool,
wherein the controller is configured to determine whether the electric power tool is in proper state, and, if it is determined that the electric power tool is in improper state, to report the improper state of the electric power tool via the informing unit regardless of whether the operation mode is the drive enabled mode or the drive disabled mode.

4. A hand-held electric power tool comprising:
a motor;
a trigger switch used to input a drive command of the motor by external operation;
a main power switch used to input a switching command for enabling/disabling driving of the motor by external operation;
a controller that switches an operation mode to one of a drive enabled mode in which driving of the motor is enabled and a drive disabled mode in which driving of the motor is disabled in accordance with the switching command from the main power switch, the controller in the drive enabled mode controlling driving of the motor in accordance with the drive command input from the trigger switch; and
an informing unit that reports an operation state of the electric power tool,
the controller being configured to determine whether the electric power tool is in proper state and, if the electric power tool is in improper state, to report the improper state of the electric power tool via the informing unit regardless of whether the operating mode is the drive enabled mode or the drive disabled mode.

5. The hand-held electric power tool according to claim 4,
wherein the informing unit includes one or more indicator lamps for displaying whether the operating mode is the drive enabled mode or the drive disabled mode,
wherein the controller is configured to switch a lighting state of the indicator lamp to a lighting state different from the drive enabled mode and the drive disabled mode upon determining that the electric power tool is in improper state, so as to report the improper state of the electric power tool.

6. The hand-held electric power tool according to claim 4,
wherein the controller is configured to determine whether the electric power tool is proper in a plurality of states and, if it is determined that the electric power tool is improper in any one of the plurality of states, to report content of the improper state via the informing unit.

7. The hand-held electric power tool according to claim 4,
wherein the controller is configured to stop an improper state report from the informing unit in response to establishment of a specified report stop condition, upon reporting the improper state of the electric power tool via the informing unit while the operation mode is the drive disabled mode.

8. The hand-held electric power tool according to claim 7,
wherein the controller is configured to determine that the report stop condition is established in response to a report time of the improper state reaching a specified time while the operation mode of the controller is the drive disabled mode.

9. The hand-held electric power tool according to claim 7,
wherein the controller is configured to determine that the report stop condition is established in response to a battery voltage of a battery that supplies electric power to the electric power tool dropping to a specific threshold voltage.

10. The hand-held electric power tool according to claim 7,
wherein the controller is configured to determine that the report stop condition is established in response to a report stop command input by external operation of a user.

11. The hand-held electric power tool according to claim 4,
wherein the trigger switch includes a lock release portion for fixing the trigger switch to a non-operation position and for releasing the position fixing of the trigger switch by external operation.

12. The hand-held electric power tool according to claim 3,
wherein the informing unit includes one or more indicator lamps for displaying whether the operating mode is the drive enabled mode or the drive disabled mode,
wherein the controller is configured to switch a lighting state of the indicator lamp to a lighting state different from the drive enabled mode and the drive disabled mode upon determining that the electric power tool is in improper state, so as to report the improper state of the electric power tool.

13. The hand-held electric power tool according to claim 3,
wherein the controller is configured to determine whether the electric power tool is proper in a plurality of states and, if it is determined that the electric power tool is improper in any one of the plurality of states, to report content of the improper state via the informing unit.

14. The hand-held electric power tool according to claim 3,
wherein the controller is configured to stop an improper state report from the informing unit in response to establishment of a specified report stop condition, upon reporting the improper state of the electric power tool via the informing unit while the operation mode is the drive disabled mode.

15. The hand-held electric power tool according to claim 14,
wherein the controller is configured to determine that the report stop condition is established in response to a report time of the improper state reaching a specified time while the operation mode of the controller is the drive disabled mode.

16. The hand-held electric power tool according to claim 14,
wherein the controller is configured to determine that the report stop condition is established in response to a battery voltage of a battery that supplies electric power to the electric power tool dropping to a specific threshold voltage.

17. The hand-held electric power tool according to claim 14,
wherein the controller is configured to determine that the report stop condition is established in response to a report stop command input by external operation of a user.

18. The hand-held electric power tool according to claim 1,
wherein the trigger switch includes a lock release portion for fixing the trigger switch to a non-operation position and for releasing the position fixing of the trigger switch by external operation.
